(19) United States
(12) Patent Application Publication
(10) Pub. No.: US 2026/0018153 A1
(43) Pub. Date: Jan. 15, 2026

(54) ACOUSTIC ARTICLE

(71) Applicant: 3M INNOVATIVE PROPERTIES COMPANY, St. Paul, MN (US)

(72) Inventors: Keisuke Sawamoto, Kanagawa-ken (JP); Daigo Yasuda, Tokyo (JP); Hideyuki Okada, Kanagawa (JP); Tadahiro Takashina, Kanagawa (JP)

(21) Appl. No.: 18/993,607

(22) PCT Filed: Jul. 21, 2023
(86) PCT No.: PCT/IB2023/057471

§ 371 Date: Jan. 13, 2025

(30) Foreign Application Priority Data
Jul. 22, 2022 (JP) 2022-117118

(51) Int. Cl. G10K 11/168; B32B 3/26; B32B 5/02; B32B 5/32

(52) U.S. Cl. CPC G10K 11/168; B32B 3/266; B32B 5/022; B32B 5/32; B32B 2307/102

(57) ABSTRACT

Object Provided are acoustic article s that take into account the frequency dependence of acoustic performance due to high bulk density and laminated structure. Solution Means The acoustic article s include a first member 2 in sheet form made of a porous material, a first skin member 4 provided on a first primary surface of the first member on one side in the thickness direction, a second member 3 in sheet form made of a porous material. and a second skin member 6 provided on a second primary surface of the second member 3 on the other side in the thickness direction. The first member and the second member are laminated, with the first member and the second member secured to each other at least partially in the planar direction.

### TECHNICAL FIELD

The present invention relates to acoustic articles.

### BACKGROUND

As previously existing acoustic articles, the ones described in Patent Document 1 are known. Patent Document 1, JP 2021-500610 T, discloses, as acoustic articles, a member in sheet form including a porous layer containing porous carbon, for example.

### SUMMARY

### Technical Problem

Here, there has been a need for acoustic articles that take into account the frequency dependence of acoustic performance due to high bulk density and laminated structure.

Therefore, an object of the present disclosure is to provide acoustic articles that take into account the frequency dependence of acoustic performance due to high bulk density and laminated structure.

### Solution to Problem

An acoustic article according to one aspect of the present disclosure includes: a first member in sheet form made of a porous material: a first skin member provided on a first primary surface of the first member on one side in the thickness direction: a second member in sheet form made of a porous material: and a second skin member provided on a second primary surface of the second member on the other side in the thickness direction, in which the first member and the second member are laminated, with the first member and the second member secured to each other at least partially in the planar direction.

A method for manufacturing an acoustic article according to one aspect of the present disclosure includes: preparing a first member in sheet form made of a porous material, the first member including a first skin member provided on the first primary surface of the first member: preparing a second member in sheet form made of a porous material, the second member including a second skin member provided on the second primary surface of the second member: and laminating the first member and the second member with the first skin member and the second skin member positioned on the outer sides in the thickness direction when laminated, and with the first member and the second member secured to each other at least partially in the planar direction.

### Advantages

According to the present disclosure, it is possible to provide acoustic articles that take into account the frequency dependence of acoustic performance due to high bulk density and laminated structure.

### BRIEF DESCRIPTION OF DRAWINGS

FIGS. 1(a) to 1(c) are each a schematic cross-sectional view of an acoustic article according to an embodiment.

FIGS. 2(a) to 2(c) are each a schematic cross-sectional view of an acoustic article according to a modification.

FIGS. 3(a) and 3(b) are each a schematic plan view of an acoustic article according to a modification.

FIGS. 4(a) and 4(b) are each a schematic cross-sectional view of an acoustic article according to a modification.

FIGS. 5(a) and 5(b) are each is a schematic plan view of an acoustic article according to a modification.

FIGS. 6(a) and 3(b) are each a schematic cross-sectional view of an acoustic article according to a modification.

FIGS. 7(a) and 7(b) are each a table showing test conditions.

FIGS. 8(a) to 8(d) are each a table showing test conditions.

FIGS. 9(a) and 9(b) are each a graph showing test results.

FIGS. 10(a) and 10(b) are each a graph showing test results.

FIGS. 11(a) and 11(b) are each a graph showing test results.

FIGS. 12(a) and 12(b) are each a graph showing test results.

### DESCRIPTION OF EMBODIMENTS

Embodiments of the present disclosure will be described below in detail with reference to the drawings.

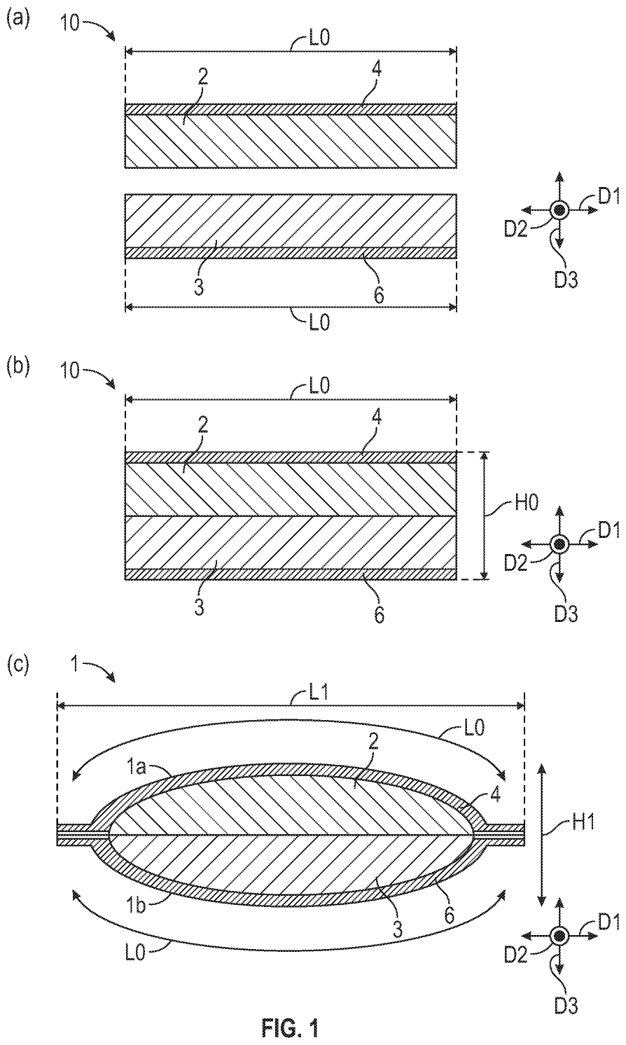

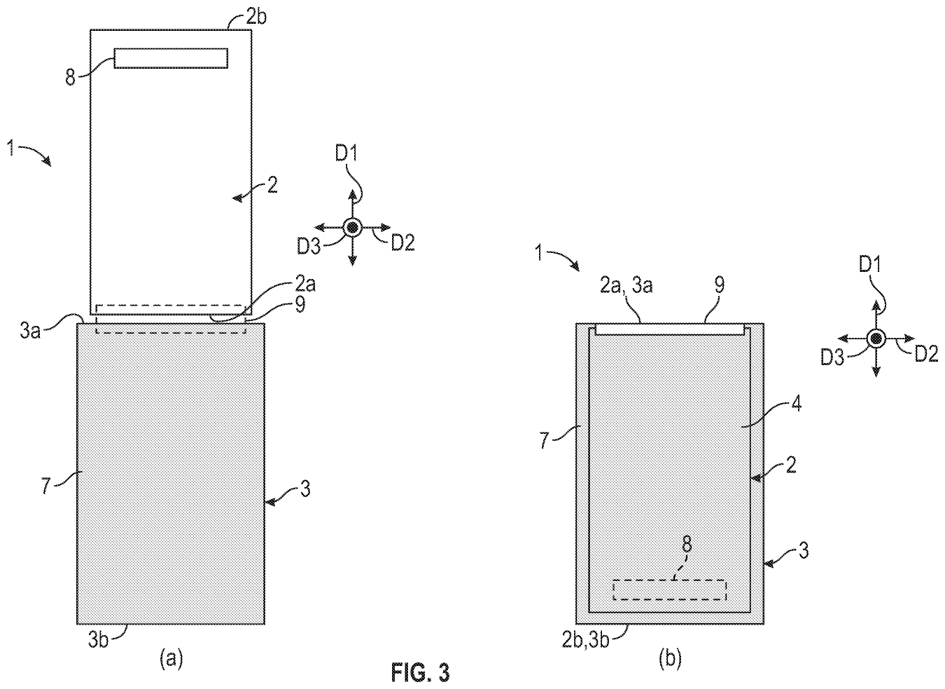

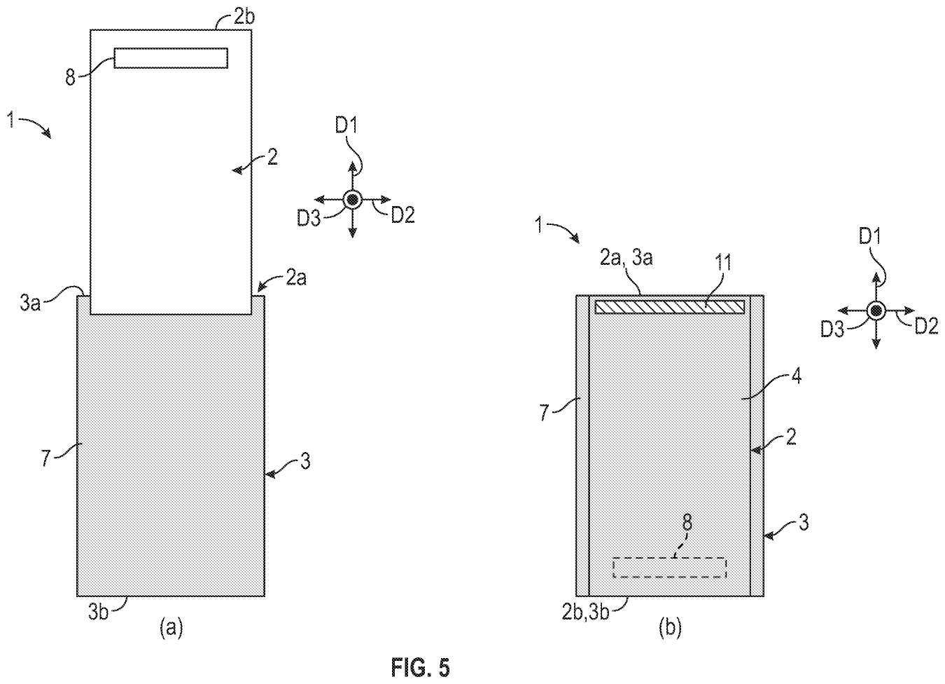

As shown in FIG. 1(c), an acoustic article 1 according to an embodiment includes a first member 2 and a second member 3. The first member 2 and the second member 3 are laminated in a state where those are secured to each other at least partially in the planar direction. “Laminated” when used here does not mean the members have to be completely secured in the laminated state, and includes a state where they can be separated from each other after laminated, as illustrated in FIGS. 3 and 5 described below. In the present embodiment, the first member 2 and the second member 3 are secured to each other by fusion at both edge portions in the first direction D1 parallel to the planar direction.

The acoustic article 1 has a pair of primary surfaces 1a and 1b opposing in the thickness direction. The pair of primary surfaces 1a and 1b are provided with skin members 4 and 6 each made of a nonwoven fabric. The skin members 4 and 6 are secured to each other by fusion at both edge portions of the acoustic article 1 in the first direction D1, sandwiching the first member 2 and the second member 3. The fusion is performed by either or both of pressure fusion and heat fusion. Pressure fusion is a method of performing fusion by applying pressure to each of the members 2, 3, 4, and 6. Heat fusion is a method of performing fusion by applying heat to each of the members 2, 3, 4, and 6. Fusion also includes sealing, in which a gap is filled with a filler.

As shown in FIGS. 1(a) and 1(b), before securing, the skin member 4, the first member 2, the second member 3, and the skin member 6 are laminated in this order, thereby configuring a laminate 10. As shown in FIG. 1(a), the first member 2 with a dimension L0 and the second member 3 with a dimension L0 are prepared and superimposed as shown in FIG. 1(b). The laminate 10 is cut to an appropriate length at both edge portions in the first direction D1 and then secured by fusion. This makes the acoustic article 1 shown in FIG. 1(c). Note that the dimension L1 of the acoustic article 1 in the first direction D1 is smaller than the dimension L0 of the laminate 10 in the first direction D1 after the cutting. The length of the primary surface la of the acoustic article 1 when viewed from the second direction D2 parallel to the planar direction and orthogonal to the first direction D1 is substantially equal to the dimension L0. In the acoustic article 1, the first member and the second member are compressed by the tension of the skin members 4 and 6. Therefore, the thickness H1 of the acoustic article 1 is thinner than the thickness H0 of the laminate 10. The thickness is a direction orthogonal to the first direction D1 and the second direction D2. Although the dimension is not particularly limited, the dimension L1 is set to about from 30 to 1300 mm. Although the thickness is not particularly limited, the thickness H1 is set to about from 10 to 60 mm. Of the thickness H1, thicknesses of the skin members 4 and 6 are about from 0.1 to 1 mm, and the remaining thickness is the thicknesses of the first member 2 and the second member 3. The thickness of the first member 2 and the thickness of the second member 3 may be equal to each other but may also be different from each other. If different, the thickness of the first member 2 may be in a range of from 10 to 1000% with respect to the thickness of the second member 3.

Next, each member will be described in detail.

### Second Member

A second member 3 is a member in sheet form made of a porous material. The second member 3 may include a porous layer and at least one filler dispersed in the porous layer. The second member 3 includes an air gap adjacent to the porous layer. For example, the second member 3 may include a porous layer and a non-uniform filler containing porous particles and having a mean surface area of 0.1 m²/g or more and 10000 m²/g or less, and the second member 3 may have an airflow resistance value of 100 MKSRayls or more and 5000 MKSRayls or less. As the porous particles, porous carbon can also be used. For example, the second member 3 may include a porous layer and a non-uniform filler that is received by the porous layer, has a mean particle size of 1 μm or more and 1000 μm or less, and has a mean surface area of 0.1 m²/g or more and 800 m²/g or less, and the second member 3 may have an airflow resistance value of 100 MKSRayls or more and 8000 MKSRayls or less. As the second member 3, 3M (trade name) Flexile Acoustic Material FAB series (manufactured by 3M Company) or the like may be used.

The second member 3 includes one or more porous layers. Useful porous layers include, but are not limited to, nonwoven fiber layers, perforated films, microparticle beds, open cell foams, fiberglass, nets, woven fabrics, and a combination of them.

A nonwoven fiber layer designed to contain fine fibers can be an acoustic absorption material effective in aerospace applications, automotive applications, transportation applications, and architectural applications. Nonwoven materials having a plurality of fine fibers can be particularly effective at high sound frequencies where the high surface area of the structure is a regime that promotes viscous dissipation of sound energy. The nonwoven layer may be made of fiberglass. The polymer nonwoven layer can be made, for example, by meltblowing or melt spinning.

In meltblowing, one or more thermoplastic polymer streams are extruded through a die including tightly arranged orifices and attenuated by a convergent flow of hot air at high velocity, and form fine fibers. It is possible to provide a meltblown nonwoven fiber layer by collecting these fine fibers onto the surface. Depending on selected operational parameters, for example, the degree of solidification from a molten state, the collected fibers may be semicontinuous or essentially discontinuous. In certain exemplary embodiments, the meltblown fibers of the present disclosure may be oriented at the molecular level. The fibers can be interrupted by defects in the melt, intersection of formed filaments, excessive shearing due to turbulence used to reduce the fiber diameter, or other events occurring in the formation process. These have been found to be generally semicontinuous or to have a length much longer than the distance between entanglements of the fibers, and therefore individual fibers cannot be removed from the fiber mass as is from end to end.

In melt spinning, nonwoven fibers are extruded from a series of orifices as filaments and cooled and solidified to form fibers. The filament is passed through an air space in which a moving air flow can be included, the filament is cooled and passed through a reduced diameter (that is, stretching) unit, and at least partial stretching of the filament is assisted. Fibers made by the melt spinning method can be “spunbonded”, whereby a web including a set of melt spun fibers is collected as a fibrous web and optionally subjected to one or more bonding operations to fuse the fibers together. Melt-spun fibers generally have a larger diameter than that of meltblown fibers.

The fibers can be made from a polymer selected from polyolefin, polypropylene, polyethylene, polyester, polyethylene terephthalate, polybutylene terephthalate, polyamide, polyurethane, polybutene, polylactic acid, polyphenylene sulfide, polysulfone, liquid crystal polymers, polyethylene-co-vinyl acetate, polyacrylonitrile, cyclic polyolefins, or copolymers or blends thereof, in an amount of at least 35 wt. % of the total weight of a plurality of fibers. Suitable fiber materials also include elastomeric polymers.

### First Member

A first member 2 is a member in sheet form made of a porous material. The first member 2 may be a nonwoven fabric member having high sound absorbency and heat insulation performance by being composed of an ultrafine fiber group so as to contain air between complicatedly entangled fibers. As the first member 2, for example, 3M (trade name) Thinsulate (trade name) Acoustic Insulation TF series, SF series (manufactured by 3M Company), or the like is used. For example, the first member 2 is a member obtained by mixing PP meltblown fibers and PET short fibers. As the material of the fibers of the first member 2, for example, fibers described in paragraph 0020, felt, glass wool, or the like is adopted. The first member 2 alone has characteristics such as sound absorbency and heat insulation. Skin member

Skin members 4 and 6 are sheet members made of a nonwoven fabric. Materials such as a meltblown nonwoven fabric and a spunbonded nonwoven fabric are adopted. In addition, as the material of the fibers of the skin members 4 and 6, for example, the fibers described in paragraph 0020 can be adopted, and in particular, PP, PET, cellulose, or the like is adopted. The skin members 4 and 6 have higher waterproofness and shape retention than the first member 2 and the second member 3 have, and have a function of protecting the first member 2 and the second member 3. Unlike the first member 2 and the second member 3, the skin members 4 and 6 have a feature of high tear strength.

Next, operations and effects of the acoustic article 1 according to the present embodiment will be described.

The acoustic article 1 includes a first member 2 in sheet form made of a porous material, a first skin member 4 provided on a first primary surface of the first member on one side in the thickness direction, a second member 3 in sheet form made of a porous material, and a second skin member 6 provided on a second primary surface of the second member 3 on the other side in the thickness direction. According to such a configuration, the combination of the first member 2 and the second member 3 can be adjusted so as to have a structure suitable for the place and situation to be applied. Therefore, it is possible to provide the acoustic article 1 that takes into account the frequency dependence of acoustic performance due to high bulk density and laminated structure.

In another embodiment, the first member 2 and the second member 3, each having mutually different advantages, may be combined, and in this case, the acoustic performance can be improved in a state where the thickness and cost are suppressed as compared with a case where the thickness and cost of a single member are increased. For example, the second member 3 may have an advantage of having good acoustic performance at low to medium frequencies even if it is thin. The first member 2 may have an advantage of efficiently absorbing a bulky mid to high frequency sound. In a case where acoustic performance equivalent to that of the present embodiment is to be obtained only by increasing the thickness of a single member, the thickness and the cost increase more than required. The first member and the second member are laminated in a state of being secured to each other at least partially in the planar direction. Therefore, the acoustic article can be distributed in a state in which a combination or positional relationship of members for obtaining desired acoustic performance is maintained.

The acoustic article 1 has a four-layer structure. The acoustic article 1 may not only be entirely made of a porous material, but also the skin members 4 and 6 need not be made of a porous material. In the acoustic article 1, at least the first member 2 and the second member 3 in the four-layer structure are only required to be a porous material.

In the acoustic article 1 according to the present embodiment, it is possible to obtain acoustic performance corresponding to a wide frequency band. Also, in the acoustic article I according to the present embodiment, it is possible to obtain acoustic performance specialized for automobiles.

It is possible to improve performance in a wide frequency band by a difference in acoustic impedance (characteristics of members) between the first member 2 and the second member 3. By simply increasing the thickness of the single member, there is a case where sound becomes easily absorbed but the acoustic impedance does not change so much.

The second member 3 may have a filler containing porous particles.

The first member 2 and the second member 3 may be secured to each other by fusion at both edge portions in the first direction D1 parallel to the planar direction. In this case, it is possible to secure them more firmly than the case of securing with a tape or the like.

The acoustic article 1 may have the pair of primary surfaces 1a and 1b opposing in the thickness direction, and the pair of primary surfaces 1a and 1b may be provided with the skin members 4 and 6 made of a nonwoven fabric, respectively. In this case, the acoustic article I can be protected from both sides by the skin members 4 and 6.

The present disclosure is not limited to the above-described embodiments.

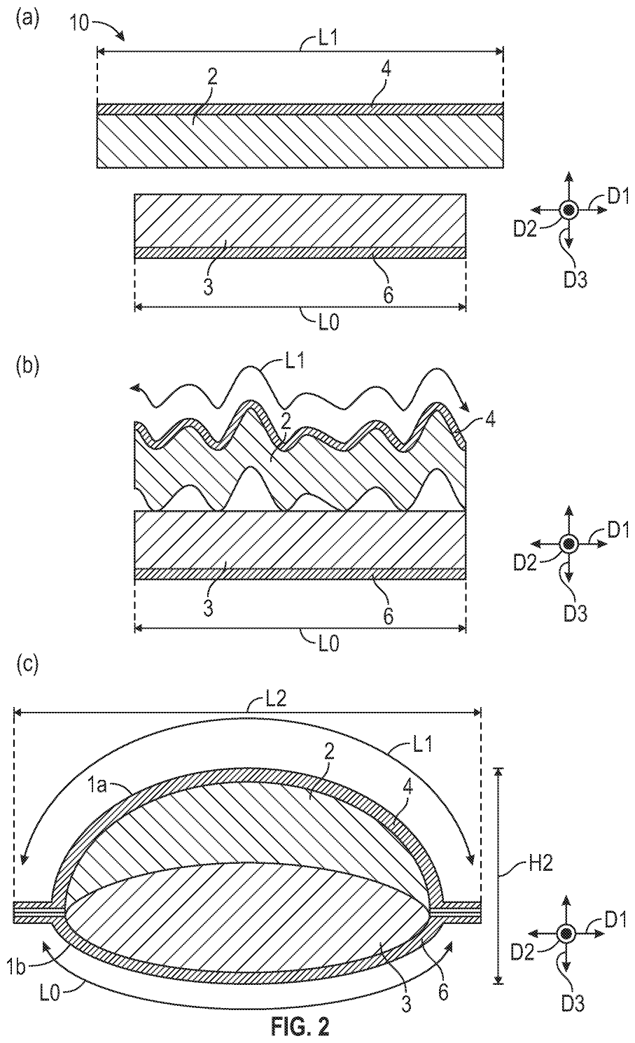

For example, as shown in FIG. 2(c), the acoustic article 1 may have the pair of primary surfaces 1a and 1b opposing in the thickness direction, and one primary surface is longer than the other primary surface when viewed from the second direction D2 parallel to the planar direction and orthogonal to the first direction D1. In the example shown in FIG. 2(c), the primary surface 1a is longer than the primary surface 1b. The dimension L1 of the skin member 4 and the first member 2 when viewed from the second direction is longer than the dimension L0 of the skin member 6 and the second member 3. As shown in FIG. 2(a), the first member 2 having the dimension L1 and the second member 3 having the dimension L0 are prepared, and as shown in FIG. 2(b), both edge portions of the first member 2 are aligned with both edge portions of the second member 3. Then, as shown in FIG. 2(b), in the state of the laminate 10, the skin member 4 and the first member 2 are in a slack state. When both edge portions of this laminate 10 are secured by fusion, the acoustic article 1 shown in FIG. 2(c) is produced. The acoustic article 1 has such a shape as to greatly expand outward in a thickness direction D3 because the skin member 4 and the first member 2 are long. The length of the primary surface 1a viewed from the second direction D2 at this time is substantially equal to the dimension L1. A thickness H2 of the acoustic article 1 becomes thicker than the thickness H1 shown in FIG. 1(c). As described above, the thick acoustic article 1 can be obtained.

Which of the primary surface 1a and the primary surface 1b to thicken is not particularly limited, and the primary surface 1b may be longer than the primary surface 1a. In this case, in the state of the laminate 10, the skin member 6 and the second member 3 are made longer than the skin member 4 and the first member 2.

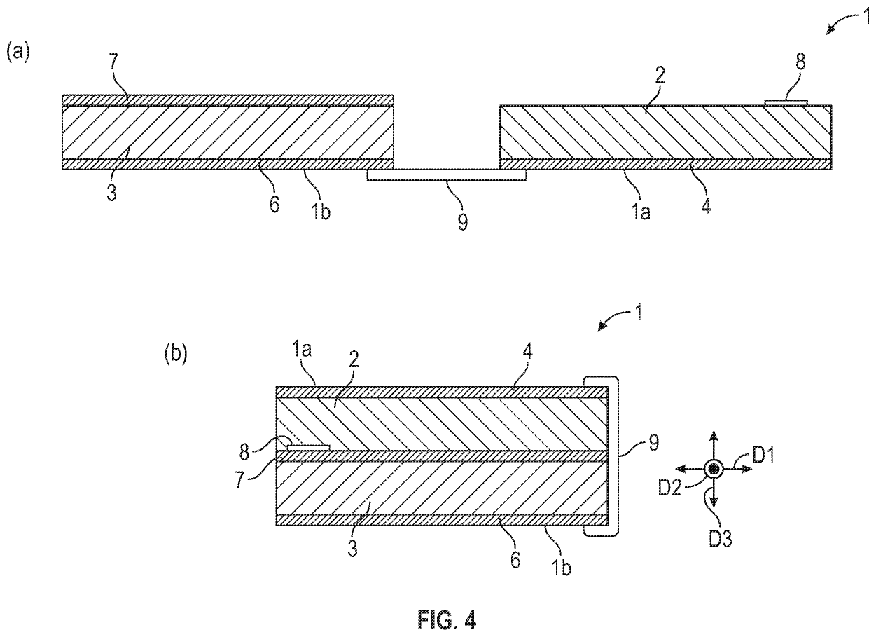

For example, as shown in FIG. 3, the first member 2 and the second member 3 are secured to each other at their first edge portions 2a and 3a in the first direction D1 parallel to the planar direction, and are separable from each other at the second edge portions 2b and 3b. As shown in FIG. 3(a), the first member 2 and the second member 3 are secured to each other with a tape member 9 on the side of the first edge portions 2a and 3a. On the other hand, the second edge portion 2b of the first member 2 and the second edge portion 3b of the second member 3 are not secured and are separable from each other at the time of product distribution. Therefore, it is possible to switch between a state in which the first member 2 and the second member 3 are opened as shown in FIG. 4(a) and a state in which the first member 2 and the second member 3 are laminated as shown in FIG. 4(b). Here, the first member 2 has a securing tape member 8 on the side of the second edge portion 2b. At the time of distribution, the adhesive surface of this securing tape member 8 is covered with a liner. On the other hand, when the acoustic article is attached to an attachment target location (such as an automobile component), as shown in FIG. 3(b), the liner is removed, and the second edge portion 2b side of the first member 2 and the second edge portion 3b side of the second member 3 are secured via the securing tape member 8.

As described above, the first member 2 and the second member 3 are fused to each other at the first edge portions 2a and 3a in the first direction D1, and are separable from each other at the second edge portions 2b and 3b. For example, in the form shown in FIG. 1(c), the thickness of the acoustic article 1 is reduced by securing both edge portions by fusion. On the other hand, when attached to an attachment target portion, the acoustic article 1 shown in FIG. 4(b) can be attached in a state where thickness is suppressed from becoming thin.

The first member 2 and the second member 3 are secured to each other with the tape member 9 at the first edge portions 2a and 3a in the first direction D1, and are separable from each other at the second edge portions 2b and 3b. In this case, both of the members 2 and 3 can be easily secured by using the tape member 9. Use of the tape member 9 makes it possible to suppress the thickness of the acoustic article 1 from becoming thin also on the side of the first edge portions 2a and 3a.

As shown in FIG. 4(b), the pair of primary surfaces 1a and 1b are provided with the skin members 4 and 6 made of a nonwoven fabric, respectively. In this case, it is possible to protect the primary surfaces 1a and 1b on the outer side in the thickness direction D3 of the secured acoustic article 1.

A skin member 7 made of a nonwoven fabric is provided between the first member 2 and the second member 3. In this case, it is possible to protect any of the members 2 and 3 (here, the second member 3) in a state where the first member 2 and the second member 3 are opened.

It is not particularly limited how to secure the first member 2 and the second member 3 on the side of the first edge portions 2a and 3b. For example, the configuration shown in FIG. 4 may be adopted. As shown in FIG. 5(b), on the side of the first edge portions 2a and 3a, the first member 2 may be secured to the second member 3 at a fusion part 11. In this case, the members 2 and 3 can be firmly secured to each other at the fusion part 11. Note that other configurations of the acoustic article 1 shown in FIG. 5 are similar to those in FIG. 3.

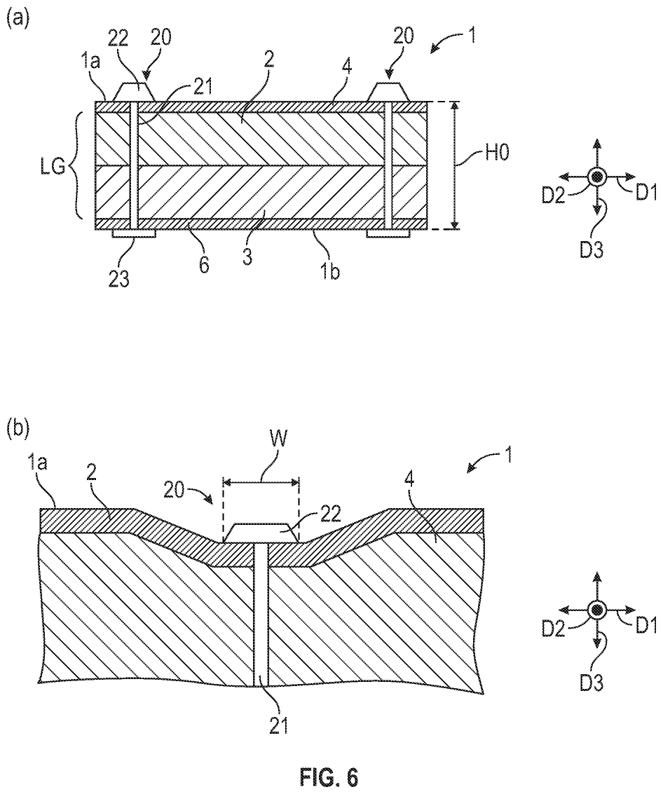

The method for securing the first member 2 and the second member 3 is not limited to fusion and the tape member. For example, as shown in FIG. 6, the acoustic article 1 may further include a pin member 20 that secures the first member 2 and the second member 3 to each other. The pin member 20 includes a main body 21 penetrating the first member 2 and the second member 3 in the thickness direction D3, and head sections 22 and 23 formed at both edge portions of the main body 21, respectively. In this case, in the acoustic article 1 of FIG. 6(a), since members are partially secured by the pin member 20, it is possible to suppress the overall thickness from becoming thin as in the acoustic article 1 of FIG. 1(c).

The pair of primary surfaces 1a and 1b are provide with skin members 4 and 6 made of a nonwoven fabric, respectively. On the other hand, the head sections 22 and 23 are positioned on the outer side in the thickness direction D3 relative to the skin members 4 and 6. Due to this, the head sections 22 and 23 press the skin members 4 and 6 higher in strength than the members 2 and 3. Therefore, it is possible to suppress the head sections 22 and 23 from getting stuck in the fibers and transmit retention force to the entire periphery of the contact part with the skin members 4 and 6 as shown in FIG. 6(b).

The main body 21 has a columnar shape extending in the thickness direction D3. The head sections 22 and 23 function as locking pieces extending in the horizontal direction within a certain angle range (for example, from 45° to 135°) from the main body 21 at both edge portions or in the middle of the main body 21. A length LG of the main body 21 is equal to or less than the total thickness of the materials of joint target (here, the total thickness H0 of the members 4, 2, 3, and 6). A width W, the number, and the material of the head sections 22 and 23 are set to conditions so that the head sections 22 and 23 do not break through the nonwoven fabrics of the skin members 4 and 6. In the example shown in FIG. 6, the head sections 22 and 23 are configured by one member extending in one direction orthogonal to the thickness direction D3, but the head sections 22 and 23 may be configured by a plurality of members extending in a plurality of directions. The width W of the head sections 22 and 23 is set to such a size that the head sections can be engaged without penetrating between fiber gaps of the nonwoven fabrics of the skin members 4 and 6. The shapes of the head sections 22 and 23 are not particularly limited, and may be trapezoidal as in the head section 22 or may be rod-like as in the head section 23. The pin member 20 may be made of resin. As the resin, for example, nylon, PET, or the like may be adopted.

### Acoustic Performance Test

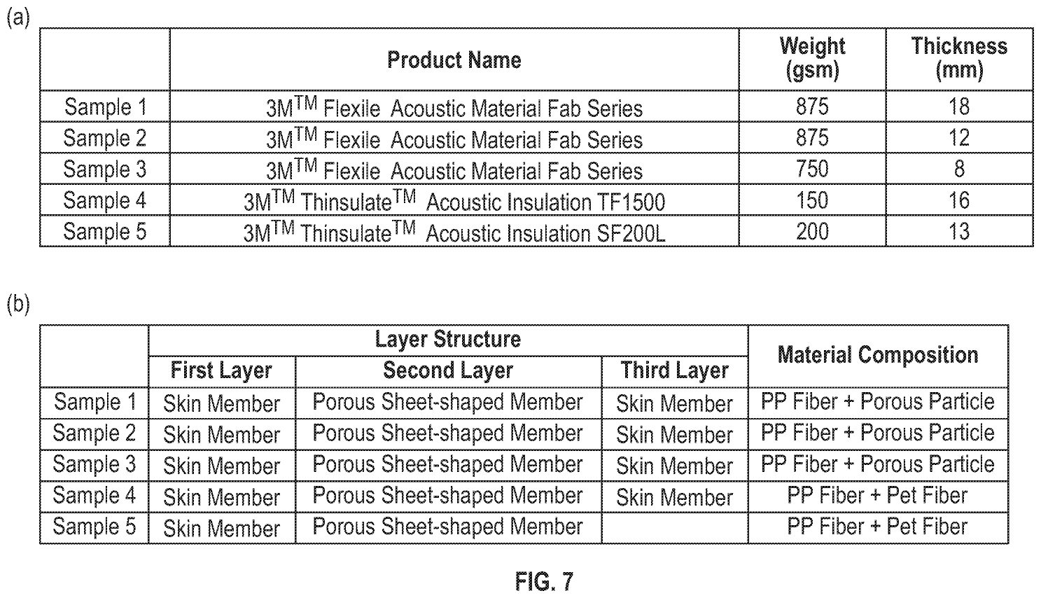

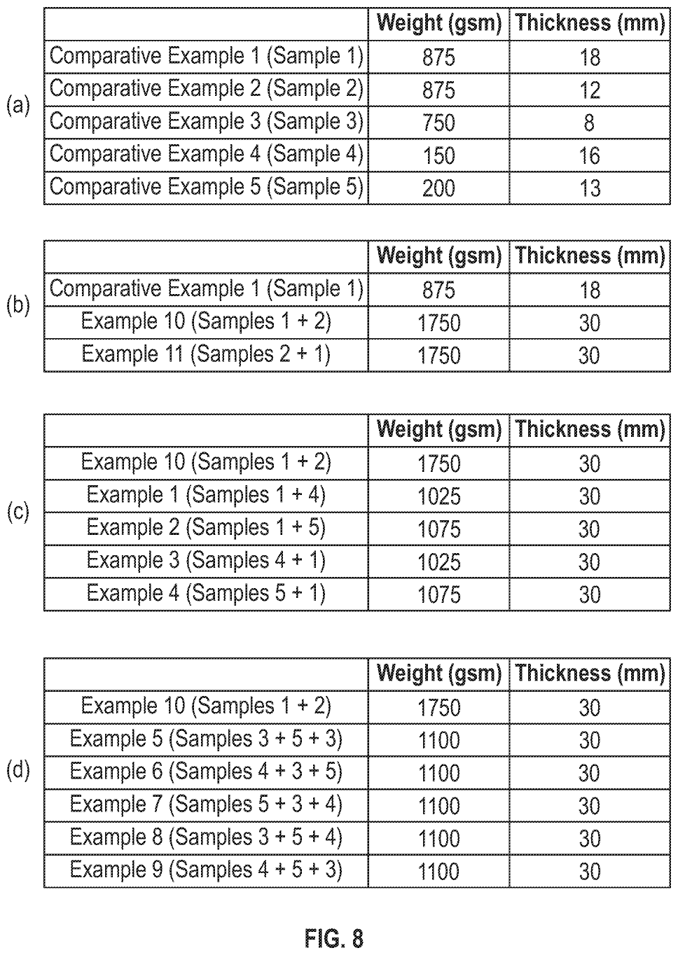

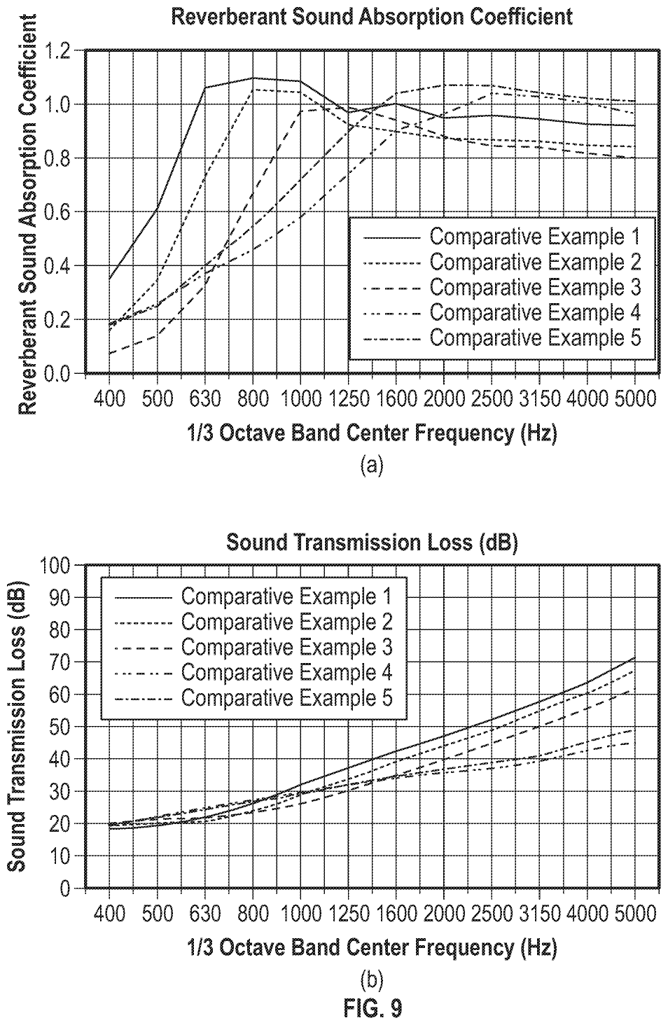

Next, an acoustic performance test will be described with reference to FIGS. 7 to 12. First, samples 1 to 5 as a single material as shown in FIGS. 7(a) and 7(b) are prepared. The samples 1, 2, and 3 correspond to the above-described second member, and the samples 4 and 5 correspond to the above-described first member. In the samples 1, 2, and 3, porous carbon is dispersed as a filler in a porous sheet-shaped member. Next, Comparative Examples 1 to 5 using the samples 1 to 5 as shown in FIG. 8(a) were prepared. The reverberant sound absorption coefficient was measured for Comparative Examples 1 to 5. This measurement was tested in accordance with JIS A 1409 “Method for measurement of sound absorption coefficients in a reverberation room”. A sound absorption coefficient measurement system (400 Hz to 5 kHz) “AbLoss” available from Nihon Onkyo Engineering Co., Ltd. was used. Sound transmission loss was measured for Comparative Examples 1 to 5. This measurement was tested in conformity to JIS A 1441-1 “Measurement of sound insulation in buildings and of building elements using sound intensity”. A transmission loss measurement system (400 Hz to 5 kHz) “AbLoss” available from Nihon Onkyo Engineering Co., Ltd. was used. The measurement results are shown in FIG. 9. Regarding the sound incident surfaces of the respective Comparative Examples and the respective examples in the acoustic performance test, the skin member side of the first layer is the incident surface for a single-layer product. For a laminated product, the sample described on the left side of the sample notation in the table of FIG. 8 is the incident surface. For example, Example 10 is described as “Samples 1+2”, but the sample 1 described on the left side is the incident surface.

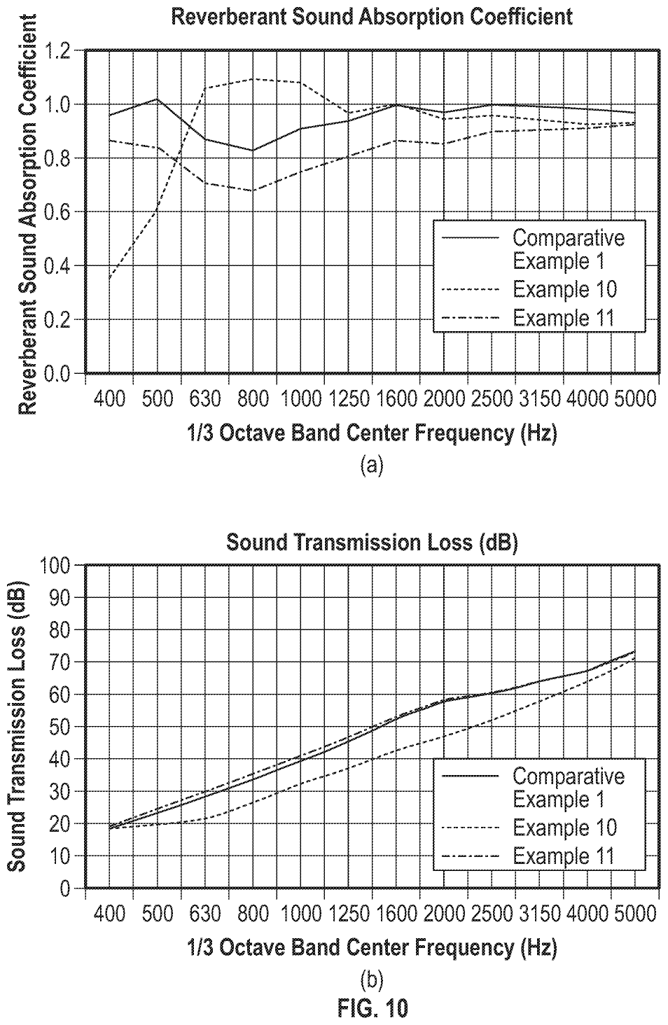

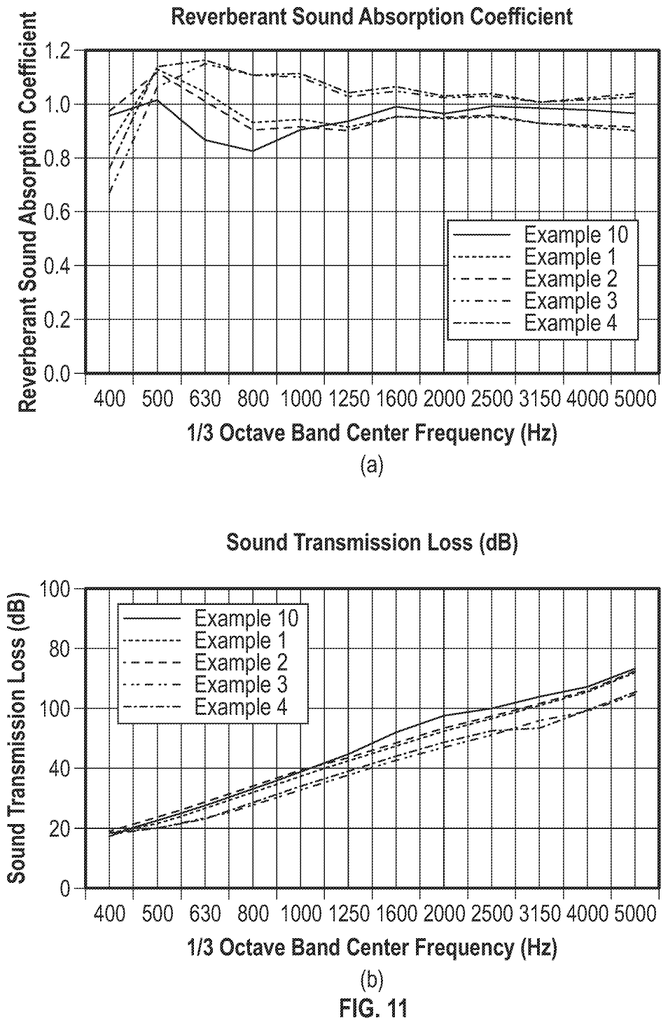

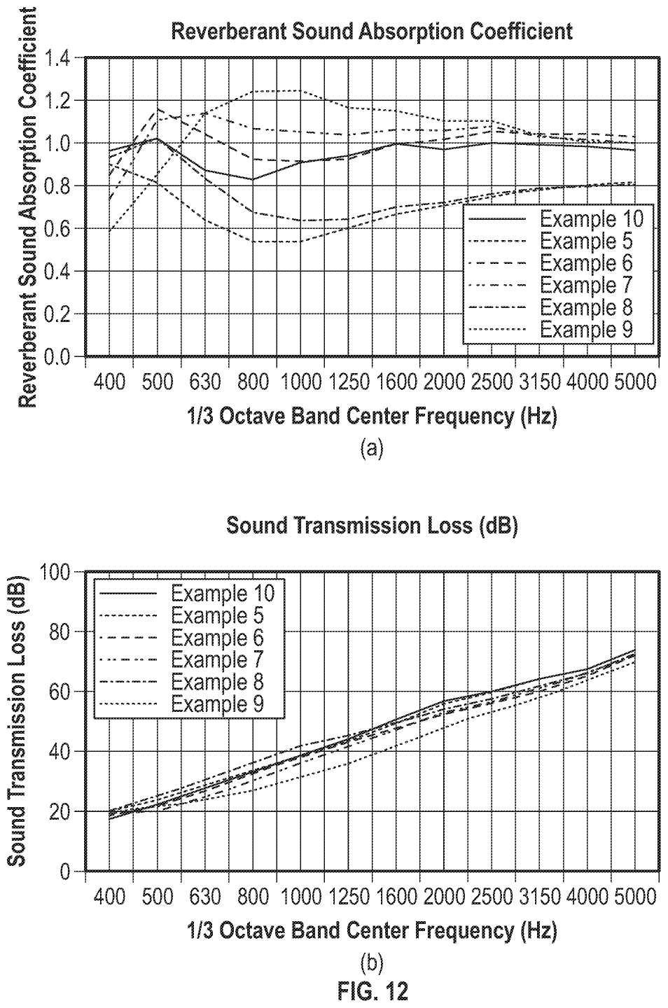

For Examples 10 and 11 in which two layers of the second members were superimposed as shown in FIG. 8(b), the reverberant sound absorption coefficient and the sound transmission loss were measured. The measurement results are shown in FIG. 10. For Examples 1 to 4 and 10 in which the first member and the second member were superimposed as shown in FIG. 8(c), the reverberant sound absorption coefficient and the sound transmission loss were measured. The measurement results are shown in FIG. 11. For Example 5 in which one-layer first member and two-layer second member were superimposed and Example 6 to 9 in which two-layer first member and one-layer second member were superimposed as shown in FIG. 8(d), the reverberant sound absorption coefficient and the sound transmission loss were measured. The measurement results are shown in FIG. 12.

The present disclosure is not limited to the above-described embodiments.

For example, the shape and the like of each sheet member are not particularly limited, and can be appropriately modified. The number, order, and the like of each layer can be appropriately changed.

The combination of the first member and the second member is not particularly limited. For example, a combination of “first member: 3M (trade name) Thinsulate (trade name) Acoustic Insulation (manufactured by 3M Company), second member: 3M (trade name) Flexible Acoustic Material FAB series (manufactured by 3M Company)” has been exemplified as an example of the combination, but a combination of “first member: 3M (trade name) Flexile Acoustic Material FAB series (manufactured by 3M Company), second member: 3M (trade name) Flexile Acoustic Material FAB series (manufactured by 3M Company)” may be adopted, a combination of “first member: 3M (trade name) Flexile Acoustic Material FAB series (manufactured by 3M Company), second member: 3M (trade name) Thinsulate (trade name) Acoustic Insulation (manufactured by 3M Company)” may be adopted, or a combination of “first member: 3M (trade name) Thinsulate (trade name) Acoustic Insulation (manufactured by 3M Company), second member: 3M (trade name) Thinsulate (trade name) Acoustic Insulation (manufactured by 3M Company)” may be adopted.

### REFERENCE SIGNS LIST

1 . . . Acoustic article
2 . . . First member
3 . . . Second member
4, 6, 7 . . . Skin member
8, 9 . . . Tape member
20 . . . Pin member
21 . . . Main body
22, 23 . . . Head section

1. An acoustic article comprising:
a first member in sheet form comprising a porous material;
a first skin member provided on a first primary surface of the first member on one side in a thickness direction;
a second member in sheet form comprising a porous material; and
a second skin member provided on a second primary surface of the second member on the other side in a thickness direction,
wherein the first member and the second member are laminated, with the first member and the second member secured to each other at least partially in a planar direction.

2. The acoustic article according to claim 1, wherein the second member comprises a filler containing porous particles.

3. The acoustic article according to claim 1, wherein the first member and the second member are secured to each other by fusion at their both edge portions in a first direction parallel to the planar direction.

4. The acoustic article according to claim 3, wherein the first primary surface is longer than the second primary surface when viewed from a direction parallel to the planar direction and orthogonal to the first direction.

5. The acoustic article according to claim 1, wherein the first member and the second member are fused to each other at their first edge portions in a first direction parallel to the planar direction, and are separable from each other at their second edge portions.

6. The acoustic article according to claim 1, wherein the first member and the second member are secured to each other with a tape member at their first edge portions in a first direction parallel to the planar direction, and are separable from each other at their second edge portions.

7. The acoustic article according to claim 5, wherein a skin member comprising a nonwoven fabric is provided between the first member and the second member.

8. The acoustic article according to claim 6, wherein a skin member comprising a nonwoven fabric is provided between the first member and the second member.

9. The acoustic article according to claim 1, further comprising a pin member that secures the first member and the second member to each other,
wherein the pin member comprises:
a main body penetrating the first member and the second member in a thickness direction; and
a head section each formed at both edge portions of the main body.

10. A method for manufacturing an acoustic article comprising:
preparing a first member in sheet form comprising a porous material, the first member including a first skin member provided on a first primary surface of the first member;
preparing a second member in sheet form comprising a porous material, the second member including a second skin member provided on a second primary surface of the second member; and
laminating the first member and the second member, with the first skin member and the second skin member positioned on outer sides in a thickness direction when laminated, and with the first member and the second member secured to each other at least partially in a planar direction.
